(19) United States
(12) Patent Application Publication
(10) Pub. No.: US 2010/0200656 A1
(43) Pub. Date: Aug. 12, 2010

(54) Full-or self-service, point-of-sale, checkout terminal

(76) Inventors: Graham Marshall, Shoreham, NY (US); Shane MacGregor, Forest Hills, NY (US)

Correspondence Address: MOTOROLA, INC., 1303 EAST ALGONQUIN ROAD, IL01/3RD, SCHAUMBURG, IL, 60196, US

(21) Appl. No.: 12/322,776

(22) Filed: Feb. 6, 2009

(51) Int. Cl. G06K 15/00

(52) U.S. Cl. 235/383

(57) ABSTRACT

A checkout terminal includes a housing having opposite end regions and a central region between the end regions, a main window supported at the central region, and a pair of side windows supported at the end regions and mutually facing each other. All of the windows bound a zone in which a product to be checked out at the terminal is located. A data capture system captures through at least one of the windows data associated with the product. A customer interface at one of the end regions enables a customer to interact with the terminal in a self-service mode of operation. A clerk interface at the other of the end regions enables a clerk to interact with the terminal in a full-service mode of operation.

### BACKGROUND OF THE INVENTION

In the retail industry, flat bed laser readers, also known as horizontal slot scanners, have been used to electro-optically read one-dimensional bar code symbols, particularly of the Universal Product Code (UPC) type, at full-service, point-of-transaction checkout terminals operated by checkout clerks in supermarkets, warehouse clubs, department stores, and other kinds of retailers for many years. As exemplified by U.S. Pat. No. 5,059,779; No. 5,124,539 and No. 5,200,599, a single, horizontal window is set flush with, and built into, a horizontal countertop of the terminal. Products to be purchased bear identifying symbols and are typically slid across, or presented to, the horizontal window through which a multitude of scan lines is projected in a generally upwards direction.

When at least one of the scan lines sweeps over a symbol associated with a product, the symbol is processed and read to identify the product. The multitude of scan lines is typically generated by a scan pattern generator that includes a laser for emitting a laser beam at a mirrored component mounted on a shaft for rotation by a motor about an axis. A plurality of stationary mirrors is arranged about the axis. As the mirrored component turns, the laser beam is successively reflected onto the stationary mirrors for reflection therefrom through the horizontal window as a scan pattern of the scan lines.

It is also known to provide a checkout terminal not only with a generally horizontal window, but also with an upright or generally vertical window that faces a clerk at the terminal, thereby constituting a dual window or bi-optical checkout terminal. The upright window is oriented generally perpendicularly to the horizontal window, or is slightly rearwardly or forwardly inclined. The laser scan pattern generator within the bi-optical terminal also projects the multitude of scan lines in a generally outward direction through the upright window toward the clerk. The generator for the upright window can be the same as, or different from, the generator for the horizontal window. The clerk slides the products past either window, e.g., from right to left, or from left to right, in a “swipe” mode. Alternatively, the clerk merely presents the symbol on the product to a central region of either window in a “presentation” mode. The choice depends on clerk preference or on the layout of the terminal.

Each product must be oriented by the clerk with the symbol facing away from the clerk and generally towards either window of the bi-optical terminal. Hence, the clerk cannot see exactly where the symbol is during scanning. In typical “blind-aiming” usage, it is not uncommon for the clerk to repeatedly swipe or present a single symbol several times before the symbol is successfully read, thereby slowing down transaction processing and reducing productivity.

The blind-aiming of the symbol is made more difficult because the position and orientation of the symbol on the product are variable. The symbol may be located either low or high, or right or left, on the product, or anywhere in between, or on any of six sides of a box-shaped product. The symbol may be oriented in a “picket fence” orientation in which the elongated parallel bars of a one-dimensional UPC symbol are vertical, or in a “ladder” orientation in which the symbol bars are horizontal, or at any orientation angle in between.

Sometimes, the upright window is not built into the terminal as a permanent installation. Instead, a vertical slot scanner is configured as a portable reader that is placed on the countertop of an existing horizontal slot scanner in a hands-free mode of operation. In the frequent event that large, heavy, or bulky products, that cannot easily be brought to the reader, have symbols that are required to be read, then the clerk may also manually grasp the portable reader and lift it off, and remove it from, the countertop for reading the symbols in a handheld mode of operation.

As advantageous as these laser-based, point-of-transaction terminals have been in processing transactions involving products associated with one-dimensional symbols, each having a row of bars and spaces spaced apart along one direction, these terminals cannot process stacked symbols, such as Code 49 that introduced the concept of vertically stacking a plurality of rows of bar and space patterns in a single symbol, as described in U.S. Pat. No. 4,794,239, or two-dimensional symbols, such as PDF417 that increased the amount of data that could be represented or stored on a given amount of surface area, as described in U.S. Pat. No. 5,304,786. Both one- and two-dimensional symbols, as well as stacked symbols, can be read by employing imaging readers each having a solid-state imager which has a one- or two-dimensional array of photocells or light sensors that correspond to image elements or pixels in a field of view of the imager. Such an imager may include a one- or two-dimensional charge coupled device (CCD) or a complementary metal oxide semiconductor (CMOS) device, as well as associated circuits for producing electrical signals corresponding to the one- or two-dimensional array of pixel data over the field of view. A programmed microprocessor or controller processes the electrical signals into data indicative of the product bearing the symbol.

It is therefore known to use a solid-state imager for capturing a monochrome image of a symbol as, for example, disclosed in U.S. Pat. No. 5,703,349. It is also known to use a solid-state imager with multiple buried channels for capturing a full color image of a symbol as, for example, disclosed in U.S. Pat. No. 4,613,895. It is common to provide a two-dimensional CCD with a 640×480 resolution commonly found in VGA monitors, although other resolution sizes are possible.

It is also known to install the solid-state imager, analogous to that conventionally used in a consumer digital camera, in the bi-optical terminal, as disclosed in U.S. Pat. No. 7,191,947 in which the dual use of both the solid-state imager and the laser scan pattern generator in the same terminal is disclosed. It is possible to replace all of the laser scan pattern generators with solid-state imagers in order to improve reliability and to enable the reading of two-dimensional and stacked symbols, as well as other targets such as non-symbols. A non-symbol can be any person, place or thing, e.g., a signature, whose image is desired to be captured at the terminal.

All of the above-described terminals are typically operated by checkout clerks. In an effort to reduce, if not eliminate, the need for checkout clerks and their associated labor cost, a number of self-service, point-of-sale, checkout terminals have been proposed. A self-service checkout terminal is operated by the customer without the aid of the checkout clerk. During operation of the self-service checkout terminal, the customer moves individual products for purchase across a window of the terminal to read their respective symbols, and then places the read products onto an exit conveyor or into a carry-out bag, if desired. The customer then pays for his or her purchases either at the self-service checkout terminal if so equipped with a credit/debit card reader, or at a central payment area that is staffed by a store employee. Thus, the self-service checkout terminal permits the customer to select, itemize, and, in some cases, pay for his or her purchases, without the assistance of the retailer's personnel.

However, self-service is not available if the aforementioned and increasingly popular, bi-optical terminal is installed at checkout. The upright window faces the clerk, not the customer. A rear wall of the bi-optical terminal rises from the countertop to a relatively tall elevation and faces the customer. As a result, the customer does not have ready access to either window of the bi-optical terminal and cannot assist in the checkout procedure, even if the customer wanted to, because the tall rear wall blocks such access. This lack of self-service potentially causes such bi-optical workstations to go unused or underutilized, and their expense to be economically unjustified. Bi-optical terminals occupy valuable real estate in a retailer's operation.

In addition, the tall rear wall tends to block a full interaction between the clerk and the customer, since both the clerk and the customer are slightly hidden from the other's view. Customer relations are important to most retailers, and the obtrusive tall rear wall constitutes not only a real physical barrier, but also hinders a full person-to-person interaction during checkout.

### SUMMARY OF THE INVENTION

One feature of this invention resides, briefly stated, in a checkout terminal or workstation, and a method of, operating the checkout terminal in a self-service mode and a full-service mode of operation. In the self-service mode, a customer operates the terminal without the assistance of store personnel. In the full-service or assisted mode, a checkout clerk or like personnel operates the terminal with or without the customer's assistance.

In accordance with one aspect of this invention, the terminal includes a housing having opposite end regions and a central region between the end regions. A main window is supported at the central region of the housing. A pair of side windows is supported at the end regions of the housing. The side windows mutually face each other. All of the windows bound a zone in which a product to be checked out at the terminal is located.

The terminal also includes a data capture system supported by the housing, for capturing through at least one of the windows data associated with the product. A customer interface is located at one of the end regions of the housing, for enabling a customer to interact with the terminal in the self-service mode of operation. A clerk interface is located at the other of the end regions of the housing, for enabling a clerk to interact with the terminal in the full-service mode of operation. The terminal of this invention is relatively inexpensive to install, and the interfaces are simple to operate, thereby maximizing their utilization. The terminal is readily operable in the full-service and self-service modes.

In a preferred embodiment, the housing is supported by a support surface, such as a countertop formed with a recess, and the housing has a base portion received in the recess. The main window is located in a generally horizontal plane, and the side windows are located in a pair of tilted planes that intersect the generally horizontal plane at obtuse angles. The central region lies in a generally horizontal plane, and the end regions have tilted portions of low elevation that lie in inclined planes that intersect the horizontal plane. The low-rise tilted portions diverge apart in a direction away from the central region.

The low-rise tilted portions tend to facilitate a fuller interaction between the clerk and the customer, since both the clerk and the customer are less hidden from the other's view as compared to the above-discussed obtrusive tall rear wall of the known bi-optical terminals. Customer relations are enhanced due to the absence of the obtrusive tall rear wall, and a fuller person-to-person interaction during checkout is obtained.

In a preferred embodiment, the data are indicia, typically one- or two-dimensional bar code symbols, on the products, and the data capture system includes an electro-optical reader for electro-optically reading the indicia. The reader is advantageously an imaging reader that operates by image capture, and includes a plurality of solid-state imagers for capturing light from the indicia through the windows along different fields of view. Each imager preferably comprises a two-dimensional, charge coupled device (CCD) array or a complementary metal oxide semiconductor (CMOS) array of submegapixel size, e.g., 752 pixels wide×480 pixels high, in order to reduce the costs of the imagers, as compared to supermegapixel arrays.

Each imager includes an illuminator for illuminating the indicia with illumination light from illumination light sources, e.g., light emitting diodes (LEDs). A controller is operative for controlling each illuminator to illuminate the indicia, for controlling each imager to capture the illumination light returning from the indicia over an exposure time period to produce electrical signals indicative of the indicia being read, and for processing the electrical signals to read the indicia. Each illuminator is only operative during the exposure time period. Each imager is controlled to capture the light from the indicia during different exposure time periods to avoid mutual interference among the illuminators.

In accordance with another aspect of this invention, the customer interface has a first interactive screen, e.g., a display and/or touch screen, located at one of the end regions, and the clerk interface has a second interactive screen, e.g., another display and/or touch screen, located at the other of the end regions. A receipt printer is located at either end region, and a keypad is also located at either end region.

In accordance with another feature of this invention, the method of operating the terminal in the self-service mode and the full-service mode of operation is performed by configuring a housing with opposite end regions and a central region between the end regions, supporting a main window at the central region of the housing, supporting a pair of side windows at the end regions of the housing and mutually facing each other, all of the windows bounding a zone in which a product to be checked out at the terminal is located, capturing through at least one of the windows data associated with the product with a data capture system supported by the housing, enabling a customer to interact with the terminal in the self-service mode of operation with a customer interface at one of the end regions of the housing, and enabling a clerk to interact with the terminal in the full-service mode of operation with a clerk interface at the other of the end regions of the housing.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a dual window, bi-optical, point-of-transaction workstation or terminal operative for reading indicia in accordance with the prior art;

FIG. 2 is a part-sectional, part-diagrammatic, schematic view of a terminal analogous to that shown in FIG. 1 in accordance with the prior art;

FIG. 3 is a perspective, exploded view of a point-of-transaction, checkout terminal operative for reading indicia on products in accordance with this invention;

FIG. 4 is a perspective view of the terminal of FIG. 3 mounted on a support surface;

FIG. 5 is a part-sectional, part-diagrammatic, view of the terminal of FIG. 3; and

FIG. 6 is a top plan view of the terminal of FIG. 3.

### DETAILED DESCRIPTION OF THE PREFERRED EMBODIMENTS

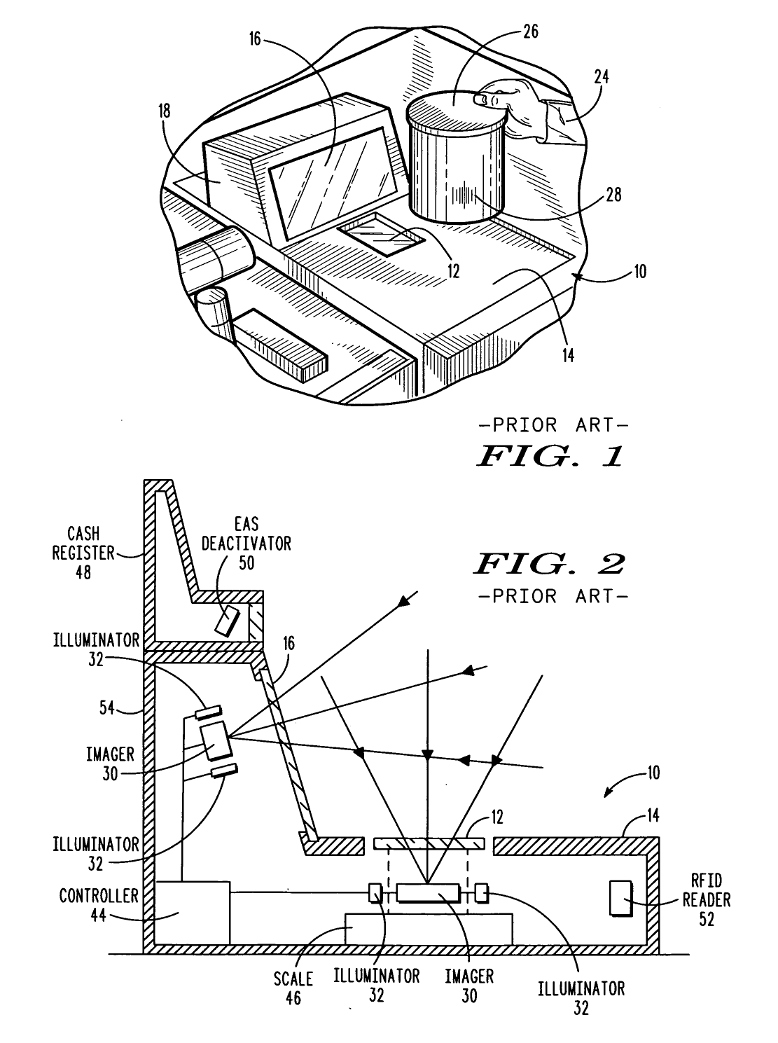

FIG. 1 depicts a dual window, bi-optical, point-of-transaction workstation or terminal 10 used in the prior art by retailers to process transactions involving the purchase of products bearing an identifying target, such as the UPC symbol described above. Terminal 10 has a generally horizontal window 12 set flush with, or recessed into, a countertop 14, and a vertical or generally vertical (referred to as “vertical” or “upright” hereinafter) window 16 set flush with, or recessed into, a raised housing portion 18 above the countertop 14.

As schematically shown in FIG. 2, a plurality of imaging readers, each including a solid-state imager 30 and an illuminator 32, are also mounted at the terminal in accordance with the prior art, for capturing light passing through either or both windows 12, 16 from a target that can be a one- or two-dimensional symbol, such as a two-dimensional symbol on a driver's license, or any document. Each imager 30 is a solid-state area array, preferably a CCD or CMOS array, of submegapixel size. Each imager 30 preferably has a global shutter. Each illuminator 32 is preferably one or more light sources, e.g., surface-mounted, light emitting diodes (LEDs), located at each imager 30 to uniformly illuminate the target.

In use, an operator 24, such as a clerk working at a supermarket checkout counter, processes a product 26 bearing a UPC symbol 28 thereon, past the windows 12, 16 by swiping the product across a respective window, or by presenting the product by holding it momentarily steady at the respective window. The symbol 28 may located on any of the top, bottom, right, left, front and rear, sides of the product, and at least one, if not more, of the imagers 30 will capture the illumination light reflected, scattered, or otherwise returning from the symbol through one or both windows.

FIG. 2 also schematically depicts that a weighing scale 46, a cash register 48, and an electronic article surveillance (EAS) deactivator 50 may be mounted at the terminal. The generally horizontal window 12 advantageously serves not only as a weighing platter for supporting a product to be weighed, but also allows the return light to pass therethrough. The register 48 can sit atop the raised housing portion 18, or be integrated therewith. Housing portion 18 has a rear wall 54. A radio frequency identification (RFID) reader 52 may also advantageously be mounted at the workstation. The reader 52 can be mounted at any location and not only below the countertop 14, as shown.

As also schematically shown in FIG. 2, the imagers 30 and their associated illuminators 32 are operatively connected to a programmed microprocessor or controller 44 operative for controlling the operation of these and other components. Preferably, the microprocessor is the same as the one used for decoding the return light scattered from the target and for processing the captured target images.

In operation, the microprocessor 44 sends successive command signals to the illuminators 32 to pulse the LEDs for a short time period of 300 microseconds or less, and successively energizes the imagers 30 to collect light from a target only during said time period, also known as the exposure time period. By acquiring a target image during this brief time period, the image of the target is not excessively blurred even in the presence of relative motion between the imagers and the target.

The energization of the imagers 30 can be manual and initiated by the operator. For example, the operator can depress a button, or a foot pedal, at the terminal. The energization can also be automatic such that the imagers operate in a continuous image acquisition mode, which is the desired mode for video surveillance of the operator, as well as for decoding two-dimensional symbols. In the preferred embodiment, all the imagers will be continuously sequentially energized for scanning symbols until such time as there has been a period of inactivity that exceeds a pre-programmed time interval. For example, if no symbols have been scanned for ten minutes, then after this time period has elapsed, the reader enters a power-savings mode in which one or more of the imagers will be omitted from sequential energization. Alternatively, illumination levels may be reduced or turned off. At least one imager will remain active for periodically capturing images. If the active imager detects anything changing within its field of view, this will indicate to the operator that a product bearing a symbol is moving into the field of view, and illumination and image capture will resume to provide high performance scanning.

As discussed above, the rear wall 54 of the bi-optical terminal rose from the countertop 14 and faced the customer in the prior art. As a result, the customer did not have ready access to either window 12 or 16 of the bi-optical terminal 10 and could not assist in the checkout procedure, even if the customer wanted to, because the rear wall 54 blocked such access. In addition, the rear wall 54 tended to block a full interaction between the clerk and the customer.

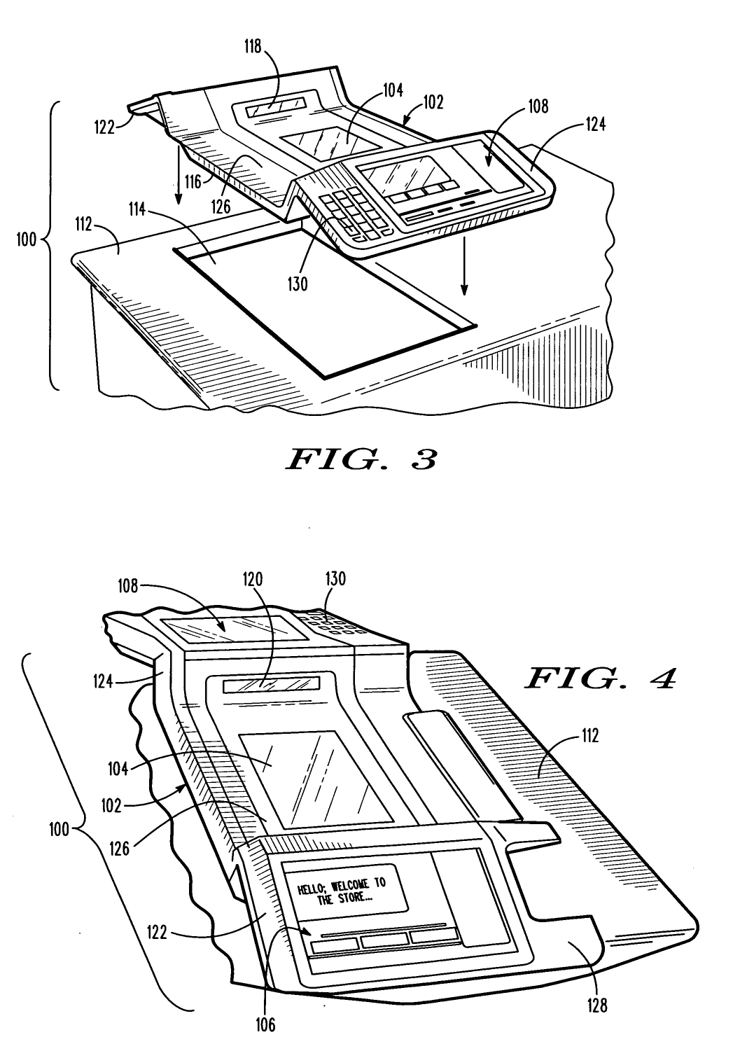

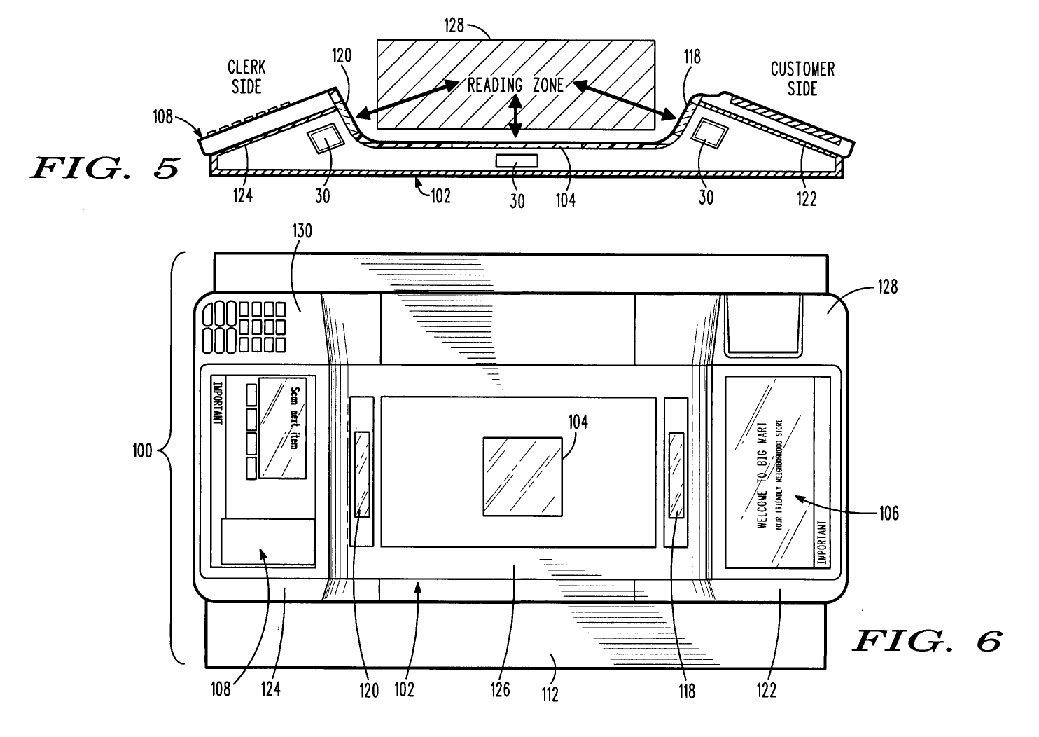

In accordance with one aspect of this invention, a checkout terminal 100, as depicted in FIGS. 3-6, includes a housing 102 having a main window 104 and a data capture system, e.g., the above-described plurality of imaging readers 30 (see FIG. 5), for capturing through the main window 104 data associated with products to be checked out at the terminal 100. A customer interface 106 is supported by the housing 102, and is operative for enabling a customer to interact with the terminal 100 in a self-service mode of operation. A clerk interface 108 is also supported by the housing 102, and is operative for enabling a clerk to interact with the terminal 100 in the full-service mode of operation. The terminal 100 of this invention is relatively inexpensive to install, and the interfaces 106, 108 are simple to operate, thereby maximizing their utilization. The terminal 100 is readily operable in the full-service and self-service modes.

In a preferred embodiment, the housing 102 is supported by a support surface 112, such as a countertop formed with a recess 114 (see FIG. 3), and the housing 102 has a base portion 116 received in the recess 114. Such countertops are routinely available in retail stores. The main window 104 is located in a generally horizontal plane, and the housing 102 has another window, preferably a pair of side windows 118, 120, each located in a rearwardly inclined tilted plane that intersects the generally horizontal plane at an obtuse angle (see FIG. 5). The side windows 118, 120 diverge apart in an upward direction away from the main window 104.

The housing 102 has a pair of opposite end regions 122, 124 and a central region 126 between the end regions 122, 124. The central region 126 lies in the generally horizontal plane, and the end regions 122, 124 have tilted portions of relatively low elevation relative to the countertop 112. The low-rise tilted portions lie in rearwardly inclined planes that intersect the horizontal plane. Preferably, the main window 104 is located in the central region 126, and is substantially flush with the upper surface of the countertop 112. The side windows 118, 120 are located in the end regions 122, 124 above the countertop 116 and mutually face each other across a reading zone 128, shown diagrammatically in FIG. 5, through which the products bearing the indicia to be read are passed. The reading zone 128 is a low valley bounded by the three windows 104, 118, 120.

One or more of the aforementioned imaging readers 30 can be positioned behind each window 104, 118, 120. Alternately, rather than using imaging readers, laser scan generators, as described above, could be employed to replace one, some, or all of the imaging readers.

The customer interface 106 has a first interactive screen, e.g., a display and/or touch screen, located at the end region 122. The customer has ready manual access to the touch screen 106 to process a transaction, and can readily see visual information on the display to process the transaction, without assistance from a clerk. The clerk interface 108 has a second interactive screen, e.g. a display and/or touch screen, located at the other end region 124. The clerk has ready manual access to the touch screen 108 to process a transaction, and can readily see visual information on the display to process the transaction on behalf of the customer.

A receipt printer 128 may be located at either end region 122, 124 to print a receipt for the customer. As illustrated, the printer 128 is located at the end region 122. It is currently preferred if the printer 128 is located at the end region 124 so that the clerk can readily replace a supply roll of receipts. It is further preferred if a slot through which the receipts are dispensed is positioned to face a central area of the terminal 100, thereby preventing the receipts from falling off the countertop and landing on the floor. A keypad 130 is preferably located at the other end region 124 to enable manual entry of information by the clerk.

Thus, the customer can approach and operate the terminal 10 from the customer interface 106 with full access to the main window 104, as well as the side windows 118, 120. The product in the reading zone 128 can be positioned so that its associated symbol faces any one of the windows 104, 118, 120. In addition, the clerk can operate the terminal 10 from the clerk interface 108 with full access to the main window 104, as well as the side windows 118, 120. With this configuration, both the clerk and the customer can process symbols with the symbols directly facing them, rather than having to first find the symbols on the products and then turn the products so that the symbols face a window.

It will be understood that each of the elements described above, or two or more together, also may find a useful application in other types of constructions differing from the types described above.

While the invention has been illustrated and described as embodied in a checkout terminal and a method of operating the same in self-service and full-service modes of operation, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1. A checkout terminal, comprising:
a housing having opposite end regions and a central region between the end regions;
a main window supported at the central region of the housing;
a pair of side windows supported at the end regions of the housing and mutually facing each other, all of the windows bounding a zone in which a product to be checked out at the terminal is located; and
a data capture system supported by the housing, for capturing through at least one of the windows data associated with the product.

2. The terminal of claim 1, and a support surface on which the housing is supported.

3. The terminal of claim 2, wherein the support surface is a countertop having a recess, and wherein the housing has a base portion received in the recess.

4. The terminal of claim 1, wherein the main window is located in a generally horizontal plane, and wherein the side windows are located in a pair of tilted planes that intersect the generally horizontal plane at obtuse angles.

5. The terminal of claim 1, wherein the central region lies in a generally horizontal plane, and wherein the end regions have tilted portions of low elevation that lie in inclined planes that intersect the horizontal plane.

6. The terminal of claim 5, wherein the tilted portions diverge apart in a direction away from the central region.

7. The terminal of claim 1, wherein the data is indicia on the products, and wherein the data capture system includes an electro-optical reader for electro-optically reading the indicia.

8. The terminal of claim 7, wherein the reader includes a plurality of solid-state imagers for capturing light from the indicia through the windows along different fields of view.

9. The terminal of claim 1, and a customer interface at one of the end regions of the housing, for enabling a customer to interact with the terminal in a self-service mode of operation; and a clerk interface at the other of the end regions of the housing, for enabling a clerk to interact with the terminal in a full-service mode of operation, wherein the customer interface has a first interactive screen, and wherein the clerk interface has a second interactive screen.

10. The terminal of claim 1, and a receipt printer located at one of the end regions, and a keypad located at one of the end regions.

11. A method of operating a checkout terminal in a self-service mode and a full-service mode of operation, comprising the steps of:
configuring a housing with opposite end regions and a central region between the end regions;
supporting a main window at the central region of the housing;
supporting a pair of side windows at the end regions of the housing and mutually facing each other, all of the windows bounding a zone in which a product to be checked out at the terminal is located;
capturing through at least one of the windows data associated with the product with a data capture system supported by the housing;
enabling a customer to interact with the terminal in a self-service mode of operation with a customer interface at one of the end regions of the housing; and
enabling a clerk to interact with the terminal in a full-service mode of operation with a clerk interface at the other of the end regions of the housing.

12. The method of claim 11, and supporting the housing on a support surface.

13. The method of claim 12, and forming the support surface with a recess, and mounting a base portion of the housing in the recess.

14. The method of claim 11, and positioning the main window in a generally horizontal plane, and positioning the side windows in a pair of tilted planes that intersect the generally horizontal plane at obtuse angles.

15. The method of claim 11, and configuring the housing so that the central region lies in a generally horizontal plane, and configuring the housing so that the end regions have tilted portions of low elevation that lie in inclined planes that intersect the generally horizontal plane.

16. The method of claim 15, and diverging the tilted portions apart in a direction away from the central region.

17. The method of claim 11, and configuring the data as indicia on the products, and configuring the data capture system as an electro-optical reader for electro-optically reading the indicia.

18. The method of claim 17, and capturing light from the indicia through the windows along different fields of view with a plurality of solid-state imagers.

19. The method-of claim 11, and configuring the customer interface with a first interactive screen located at one of the end regions. and configuring the clerk interface with a second interactive screen located at the other of the end regions.

20. The method of claim 11, and locating a receipt printer at one of the end regions, and locating a keypad at one of the end regions.
